(19) United States
(12) Patent Application Publication
(10) Pub. No.: US 2019/0222418 A1
(43) Pub. Date: Jul. 18, 2019

(54) Systems and Methods for Key Exchange in Blockchain

(71) Applicant: Walmart Apollo, LLC, Bentonville, AR (US)

(72) Inventors: John Jeremiah O'Brien, Farmington, AR (US); Aditya Prakash Hemdev, Bentonville, AR (US); Adrian Cabal, Bentonville, AR (US); Steven Jackson Lewis, Bentonville, AR (US); Chris Heeney, Bella Vista, AR (US); Joseph Jurich, JR., Molino, FL (US); Robert Cantrell, Herndon, VA (US); Todd Davenport Mattingly, Bentonville, AR (US); Brian Gerard McHale, Oldham (GB); Bruce W. Wilkinson, Rogers, AR (US); Donald High, Noel, MO (US)

(21) Appl. No.: 16/245,949

(22) Filed: Jan. 11, 2019

Related U.S. Application Data
(60) Provisional application No. 62/616,835, filed on Jan. 12, 2018.

(51) Int. Cl. H04L 9/08; H04W 12/04; G06Q 30/06; H04L 9/06; G06Q 30/00

(52) U.S. Cl. CPC H04L 9/0866; H04W 12/04071; H04W 12/0401; H04L 9/0825; G06Q 2220/00; H04L 9/0637; G06Q 30/012; H04L 2209/38; G06Q 30/06

(57) ABSTRACT

Exemplary embodiments of the present disclosure are related to a system for key exchange in a blockchain based system associated with warranty-ownership of physical objects. Embodiments of the key exchange system can include user terminal devices, one or more non-transitory computer-readable media, and a computing system.

### RELATED APPLICATION

This application claims the benefit of, and priority to, U.S. Provisional Patent Application No. 62/616,835, filed Jan. 12, 2018, the content of which is incorporated herein by reference in its entirety.

### BACKGROUND

Blockchain-based systems can be managed autonomously in a peer-to-peer network using a distributed timestamping server to provide a decentralized and distributed digital ledger.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary system for key exchange in a blockchain based system associated with warranty-ownership of physical objects in accordance with an exemplary embodiment of the present disclosure;

FIG. 2 illustrates a chain of blocks as configured in accordance with various embodiments of the present disclosure;

FIG. 3 is a diagram illustrating transactions in a blockchain in accordance with various embodiments of the present disclosure;

FIG. 4 is a flow diagram illustrating a process of building a chain of blocks in accordance with various embodiments of the present disclosure;

FIG. 5 illustrates a process of validating and adding a block to a chain of blocks in accordance with various embodiments of the present disclosure;

FIG. 6 is a block diagram of nodes configured maintain a blockchain in accordance with various embodiments of the present disclosure;

FIG. 7 is a block diagram an exemplary computing device in accordance with various embodiments of the present disclosure; and

FIG. 8 is a flowchart illustrating a process of a key exchange implemented by the blockchain warranty-ownership storage system in accordance with an exemplary embodiment.

FIG. 9 is a flowchart illustrating a process of transferring warranty-ownership via a blockchain warranty-ownership storage system in accordance with another exemplary embodiment.

### DETAILED DESCRIPTION

Described in detail herein is a system for key exchange in a blockchain based system associated with warranty-ownership of physical objects. A blockchain system can be used to track exchange of warranties, service plans, and/or ownership of a physical object. The process of warranty-ownership exchange can be streamlined with block chain. For example, when a first user purchases a physical object, i.e., a product, the user may also purchase a service plan for a particular period of time. The first user can receive a warranty card, service card, or digital record with a machine-readable representation with a unique key or hash encoded therein for the product. The unique key or hash can reference the warranty or service plan associated with the product and can reference information associated with the first user. For embodiments in which the first user can scan in the machine-readable representation he/she received using a camera on a mobile device, the mobile device can extract the hash or private key from the image of the machine-readable representation, and this purchased product associated with the hash or private key can be added into an account associated with the first user via a mobile application being executed by the mobile device. The mobile device can transmit the hash or unique key to nodes in blockchain system to add a new block to a blockchain. When ownership of the product is transferred (e.g., sold) to a second user by the first user, the first user can share product machine-readable representation encoded with the unique key or hash with the second user. The second user can scan the machine-readable representation, into his/her mobile application executed by the mobile device associated with the second user (e.g., capture an image of the machine-readable representation), and the second user's mobile device can extract the hash or unique key from the scanned machine-readable representation. The mobile application executing on the mobile device associated with the second user can be updated with the information associated with the product and a new block can be added to the blockchain in response to the mobile device transmitting the hash or unique key to nodes in a blockchain system. Information associated with the product can include, for example, repair information, review information, recall information, routine maintenance information, tracking information, etc. The physical object can be any product such as televisions, consoles, computers, electronics, furniture, clothing, movies, art, software, automobiles, planes, boats, homes, etc.

In the blockchain system of the present disclosure, the product information, such as warranty, service policy, service history, insurance information, etc., is stored using a blockchain distributed ledger. For example, when the product is a car, the user who purchases the car can alter the product by adding tinted windows, after-market sound system, accident requiring front end work, etc. These alterations can be recorded into the ledger by a technician which provides the service for the car or by the user if the alterations to the product are done by the user. The blockchain system can remind the user of upcoming service plan and warranty end dates of the product. The warranty may be provided on repair and maintenance work such as lifetime brakes or tire rotation and balancing. The system may also provide information to the owner for accident history, repair history, recall history and warrantee information.

The blockchain system can transfer warranty, service policy, service history and insurance information to the new owner of the product when the previous owner authorizes the transfer. The services provided to the previous owner can be transferred to a subsequent owner. For example, when a television is sold with a one-year streaming services, the system can transfer the streaming services to the new owner and the transfer can be recorded as a block in the blockchain.

A blockchain ID can be based upon an existing physical ID of the product, for example, the VIN of a car, or the serial number of consumer electronics and major appliances. For products without an individual ID, the system can assign an ID based upon model number, manufacture date, a hash of the transaction number, and/or customer ID. The system can also offer the alternative of adding a physical identifier to the product for differentiation. Photographs of the object can be used to document the object condition at the time of initial sale, accident, repair and item transfer.

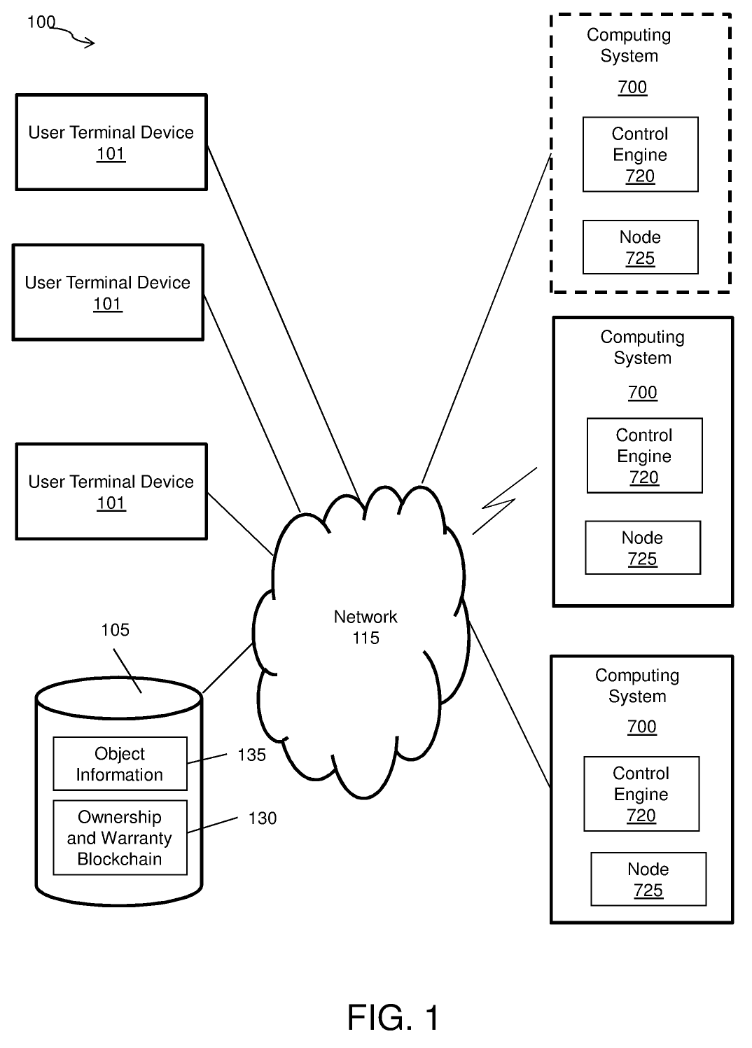

FIG. 1 illustrates an exemplary system for key exchange associated with warranty-ownership of physical objects in accordance with an exemplary embodiment. The blockchain warranty-ownership exchanging system 100 can include one or more databases 105, one or more computing systems 700, and one or more user terminal devices 101 (e.g., mobile devices associated with the users). The computing system 700 can be in communication with the databases 105 and the user terminal devices 101 via a communications network 115. The computing system 700 can implement at least one instance of a control engine 720. The control engine 720 can be an executable application executed on the computing system 700. The control engine 720 can execute processes of the blockchain warranty-ownership exchanging system 100 as described herein. The computing system can include one or more nodes 725. Each of the one or more nodes 725 can store a copy of a blockchain record and/or a shared ledger. The one or more nodes 725 can be configured to update the blocks in the blockchain record.

In an example embodiment, one or more portions of the communications network 115 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

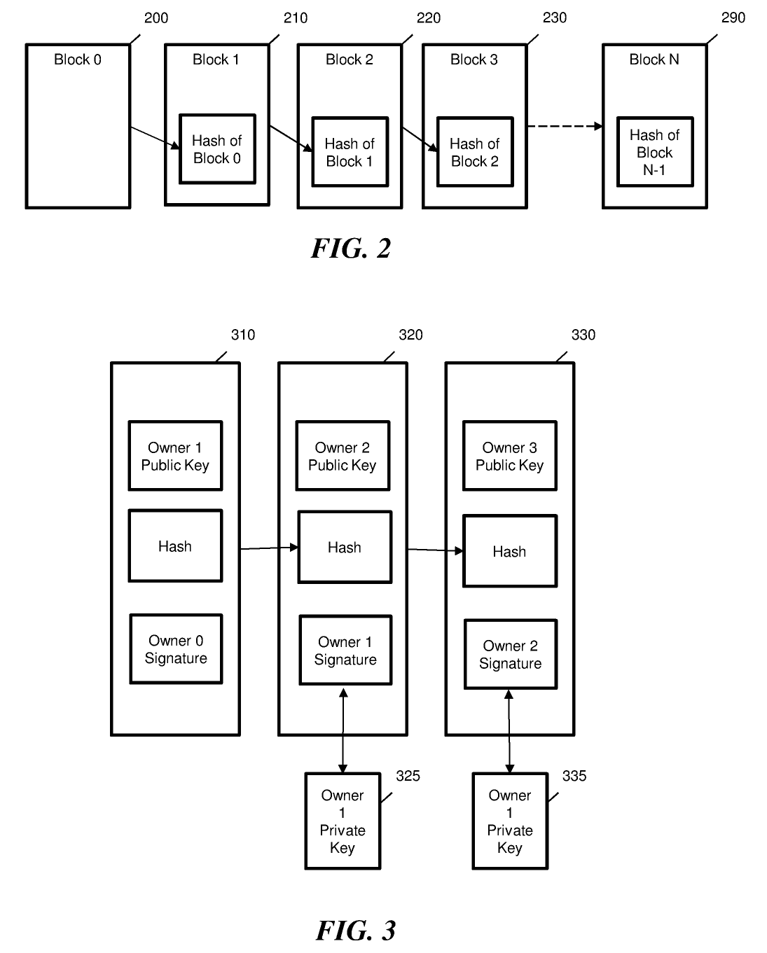

The computing system 700 includes one or more computers or processors configured to communicate with the databases 105 and the devices 101. The computing system 700 hosts one or more applications configured to interact with one or more components of the blockchain warranty-ownership exchanging system. The databases 105 may store information/data, as described herein. For example, the databases 105 can include an object information database 135 and an ownership and warranty blockchain database 130. The object information database 135 can include information associated with the physical object, such as information regarding service, insurance, repair, recall, routine maintenance, a schedule of upcoming events related to the object. The object information can also include photographs indicating object condition of the physical object at the time of initial sale, accident, repair and transfer. The ownership and warranty blockchain database 130 can be embodied as a blockchain storage system as described in FIGS. 2-7, configured to store a blockchain record or a shared ledger. The blockchain storage system can store ownership and warranty associated with the object. The databases 105 and the computing system 700 can be located at one or more geographically distributed locations from each other. Alternatively, the databases 105 can be included within first computing system 700.

In exemplary embodiments, when a user purchases a physical object, the user can generate a request from the terminal device 101 to obtain object information and ownership and warranty information related to the physical object by scanning a computer-readable representation with a hash or unique key associated with the object provided by the seller encoded therein, extracting the hash or private key to the computing system 700. The computing system 700 can execute the control engine 720 in response to receiving the request. The control engine 720 can store the request in the object information database 135, and transfer the related information associated with the object to the terminal device 101, or any other designated device, and/or generate an ownership and warranty file for the transfer of the physical object.

The ownership and warranty file can be stored in the ownership and warranty blockchain database 130 using the blockchain storage system as described in FIGS. 2-7. For example, the node 725 can generate a block in the ownership and warranty blockchain database 130. The block can store the ownership, service plan, and warranty file. A digital signature and public key can be associated with the block storing the ownership and warranty file, where the digital signature can be formed based on a user ID and the public key can be a hash of the combined hash/unique key and user ID. The block can be assigned a block ID based on one or more attributes of the object and/or a user identifier. A user can transfer the ownership to another user by providing block ID and hash or unique key associated with the public key corresponding to the block storing the ownership and warranty file. The other user can attempt to perfect the ownership and warranty file in the blockchain using the hash or unique key and the digital signature of the user transferring the ownership, service plan, and warranty file. The node 725 can verify the digital signature and public key of the block based on the hash or unique key. The node 725 can generate a subsequent block including recording the successful transfer of the ownership, service plan, and warranty file to the other user in response to verification. A digital signature of the other user and a public key can be associated to the subsequent block can be included in the subsequent block. The digital signature of the other user can be generated based on a user ID of the other user and the public key can be generated based on a hash of the hash/unique key and the user ID associated with the other user. The subsequent bock can also include a hash of the previous block in the block chain.

Each new block created in the blockchain (e.g., as the result of a transfer of ownership, service plan, and/or warranty file) can include a hash key associated with the previous block in the blockchain to form a sequential chain of blocks where each block (except the root/genesis block) includes a hash key of a previous block in the chain. For example, in the event ownership, a service plan, and/or a warranty file is transferred, a block is generated including transaction records associated the transfer. The new block can include a hash key of the block containing the ownership and warranty file. Side chains can also be created. For example, in the event there is a failed attempt to transfer ownership, a service plan, and/or warranty file, a block in a side chain is generated including transaction records associated with the failed transfer, the newly generated block can include a hash key of the block containing the ownership and warranty. However, the newly generated block may not include a hash key of the block including transaction records associated with granted access to the block containing the ownership file. Accordingly, the block containing the ownership and warranty file can be linked in two different chains.

Descriptions of some embodiments of blockchain technology are provided with reference to FIG. 2-7 herein. One or more of the user terminal devices described herein may comprise a node in a distributed blockchain system storing a copy of the blockchain record. Updates to the blockchain may comprise transfer of ownership and warranty and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it.

Now referring to FIG. 2, an illustration of a blockchain according to some embodiments is shown. In some embodiments, a blockchain comprises a hash chain or a hash tree in which each block added in the chain contains a hash of the previous block. In FIG. 2, “block 0” 200 represents a genesis block of the chain that includes the ownership and warranty file for a physical object. “Block 1” 210 contains a hash of “block 0” 200, “block 2” 220 contains a hash of “block 1” 210, “block 3” 230 contains a hash of “block 2” 220, and so forth. Continuing down the chain, block N contains a hash of block N−1. In some embodiments, the hash may comprise the header of each block. Each block added to the blockchain subsequent to the genesis block can be generated in response to a user requesting the ownership and warranty file and can include a response to the request and/or the ownership and warranty file. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of ownership and warranty records associated with the activities to the physical object, such as transferring the object, alternate the object, etc.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of a physical object that allows the owner to show possession and/or transfer the physical object using a private key. Nodes may verify that the owner is in possession of the physical object and/or is authorized to transfer the physical object based on prior transaction records when a block containing the transaction is being formed and/or verified. In some embodiments, rules themselves may be stored in the blockchain such that the rules are also resistant to tampering once created and hashed into a block.

Now referring to FIG. 3, an illustration of blockchain based transactions according to some embodiments is shown. In some embodiments, the blockchain illustrated in FIG. 3 comprises a hash chain protected by private/public key encryption. Transaction A 310 represents a transaction recorded in a block of a blockchain showing that owner 1 (recipient) obtained a physical object from owner 0 (sender). Transaction A 310 contains owner's 1 public key and owner 0's signature for the transaction and a hash of a previous block. When owner 1 transfers the physical object to owner 2, a block containing transaction B 320 is formed. The record of transaction B 320 comprises the public key of owner 2 (recipient), a hash of the previous block, and owner 1's signature for the transaction that is signed with the owner 1's private key 325 and verified using owner 1's public key in transaction A 310. When owner 2 transfers the physical object to owner 3, a block containing transaction C 330 is formed. The record of transaction C 330 comprises the public key of owner 3 (recipient), a hash of the previous block, and owner 2's signature for the transaction that is signed by owner 2's private key 335 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 3 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

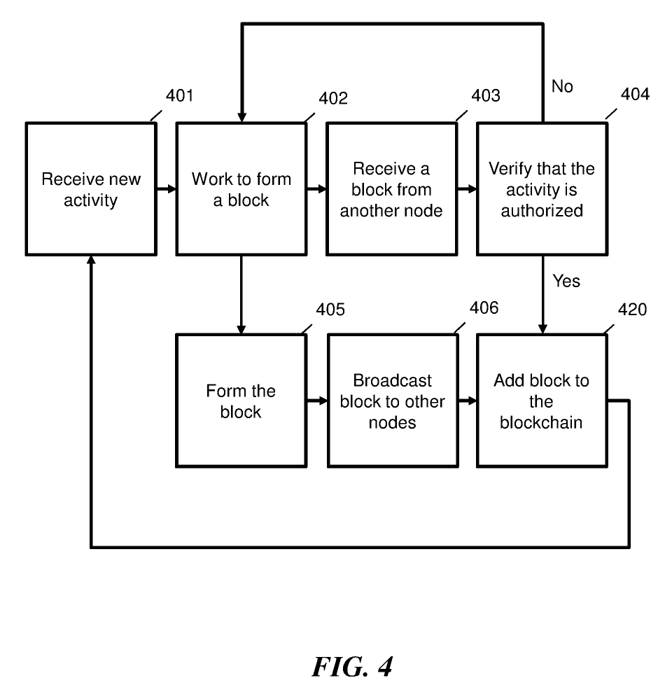

Now referring to FIG. 4, a flow diagram according to some embodiments is shown. In some embodiments, the steps shown in FIG. 4 may be performed by a processor-based device, such as a computer system, a server, a distributed server, a timestamp server, a blockchain node, and the like. In some embodiments, the steps in FIG. 4 may be performed by one or more of the nodes in a system using blockchain for record keeping, for example, the user terminal devices.

In step 401, a node receives a new activity in response to the authentication of the user terminal devices. The new activity may comprise an update to the record being kept in the form of a blockchain. In some embodiments, for blockchain supported digital or physical record keeping, the new activity can correspond to the authentication of the user terminal devices and/or the activities to the physical object according to the request generated at the user terminal device. In some embodiments, the new activity may be broadcasted to a plurality of nodes on the network prior to step 401. In step 402, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 402, if the node successfully forms a block in step 405 prior to receiving a block from another node, the node broadcasts the block to other nodes over the network in step 406. In step 420, the node then adds the block to its copy of the blockchain. In the event that the node receives a block formed by another node in step 403 prior to being able to form the block, the node works to verify that the activity (e.g., authentication of activities to the physical object) recorded in the received block is authorized in step 404. In some embodiments, the node may further check the new block against system consensus rules for blocks and activities to verify whether the block is properly formed. If the new block is not authorized, the node may reject the block update and return to step 402 to continue to work to form the block. If the new block is verified by the node, the node may express its approval by adding the received block to its copy of the blockchain in step 420. After a block is added, the node then returns to step 401 to form the next block using the newly extended blockchain for the hash in the new block.

In some embodiments, in the event one or more blocks having the same block number is received after step 420, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 401.

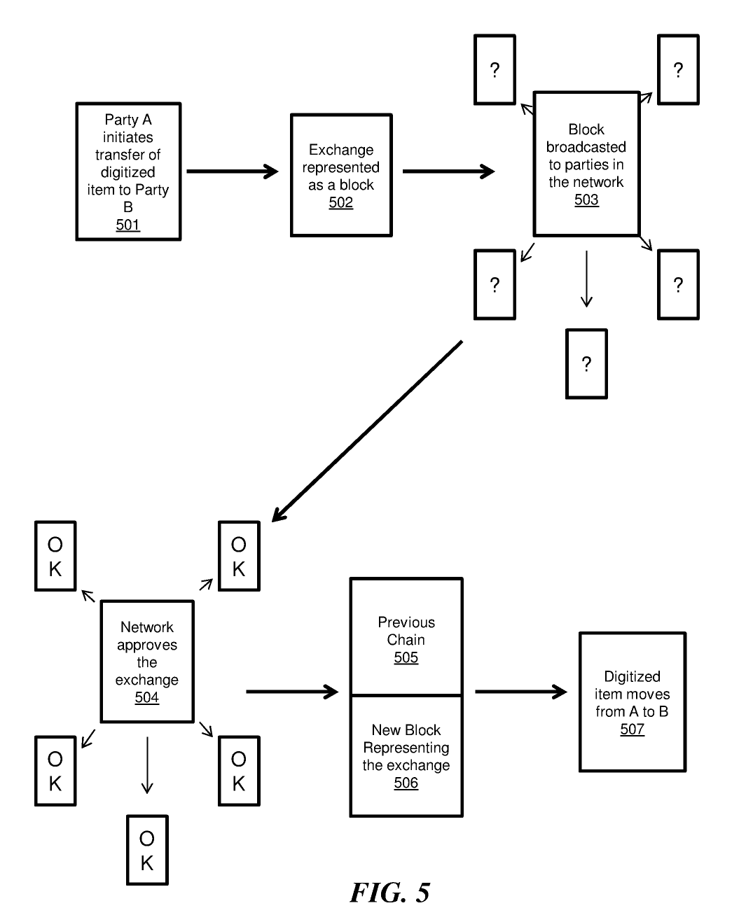

Now referring to FIG. 5, a process diagram a blockchain update according to some implementations in shown. In step 501, party A initiates the transfer of a physical object to party B. In some embodiments, Party A may prove that he has possession of the physical object by signing the transaction with a private key that may be verified with a public key in the previous transaction of the physical object. In step 502, the exchange initiated in step 501 is represented as a block. In some embodiments, the transaction may be compared with transaction records in the longest chain in the distributed system to verify part A's ownership and warranty. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, a block may represent one or more transactions between different parties that are broadcasted to the nodes. In step 503, the block is broadcasted to parties in the network. In step 504, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 506 representing the exchange is added to the existing chain 505 comprising blocks that chronologically precede the new block 506. The new block 506 may contain the transaction(s) and a hash of one or more blocks in the existing chain 505. In some embodiments, each node may then update their copy of the blockchain with the new block and continue to work on extending the chain with additional transactions. In step 507, when the chain is updated with the new block, the physical object is moved from party A to party B.

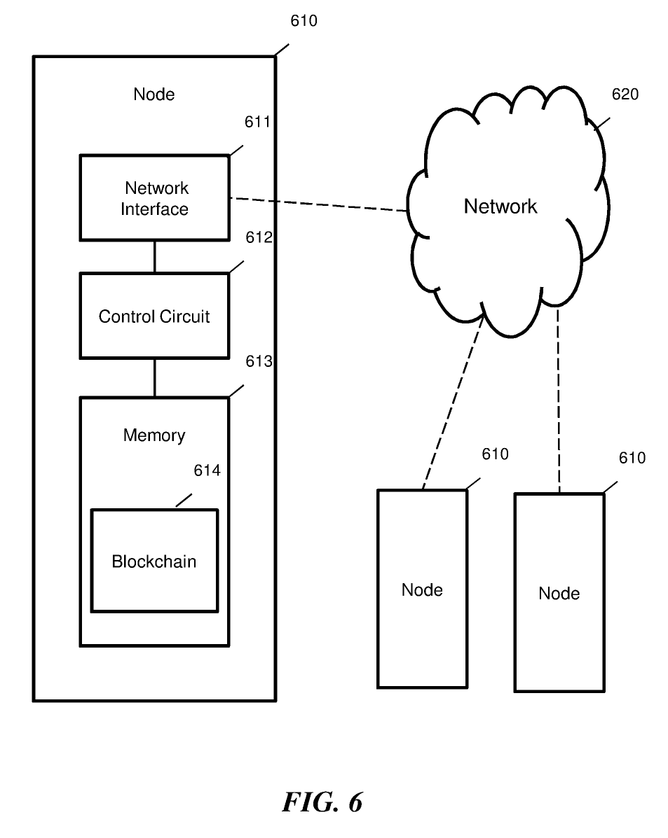

Now referring to FIG. 6, a system according to some embodiments is shown. A distributed blockchain system comprises a plurality of nodes 610 communicating over a network 620. In some embodiments, the nodes 610 may be comprise a distributed blockchain server and/or a distributed timestamp server. Each node 610 in the system comprises a network interface 611, a control circuit 612, and a memory 613.

The control circuit 612 may comprise a processor, a microprocessor, and the like and may be configured to execute computer readable instructions stored on a computer readable storage memory 613. The computer readable storage memory may comprise volatile and/or non-volatile memory and have stored upon it a set of computer readable instructions which, when executed by the control circuit 612, causes the node 610 update the blockchain 614 stored in the memory 613 based on communications with other nodes 610 over the network 620. In some embodiments, the control circuit 612 may further be configured to extend the blockchain 614 by processing updates to form new blocks for the blockchain 614. Generally, each node may store a version of the blockchain 614, and together, may form a distributed database. In some embodiments, each node 610 may be configured to perform one or more steps described with reference to FIGS. 4-5 herein.

The network interface 611 may comprise one or more network devices configured to allow the control circuit to receive and transmit information via the network 620. In some embodiments, the network interface 611 may comprise one or more of a network adapter, a modem, a router, a data port, a transceiver, and the like. The network 620 may comprise a communication network configured to allow one or more nodes 610 to exchange data. In some embodiments, the network 620 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

The blockchain system can use a peer-to-peer distributed timestamp server to generate computational proof of the chronological order of transactions. Generally, the blockchain system is secure as long as honest nodes collectively control more processing power than any cooperating group of attacker nodes. With a blockchain, the transaction records are computationally impractical to reverse.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, the blockchain may be used to ensure that a physical object was not altered after a given timestamp, that alterations made can be followed to a traceable point of origin, that only people with authorized keys can access the physical object, and/or that the holder of the physical object was authorized to transfer, alter, or otherwise act on the object.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain.

Descriptions of embodiments of blockchain technology are provided herein as illustrations and examples only. The concepts of the blockchain system may be variously modified and adapted for different applications.

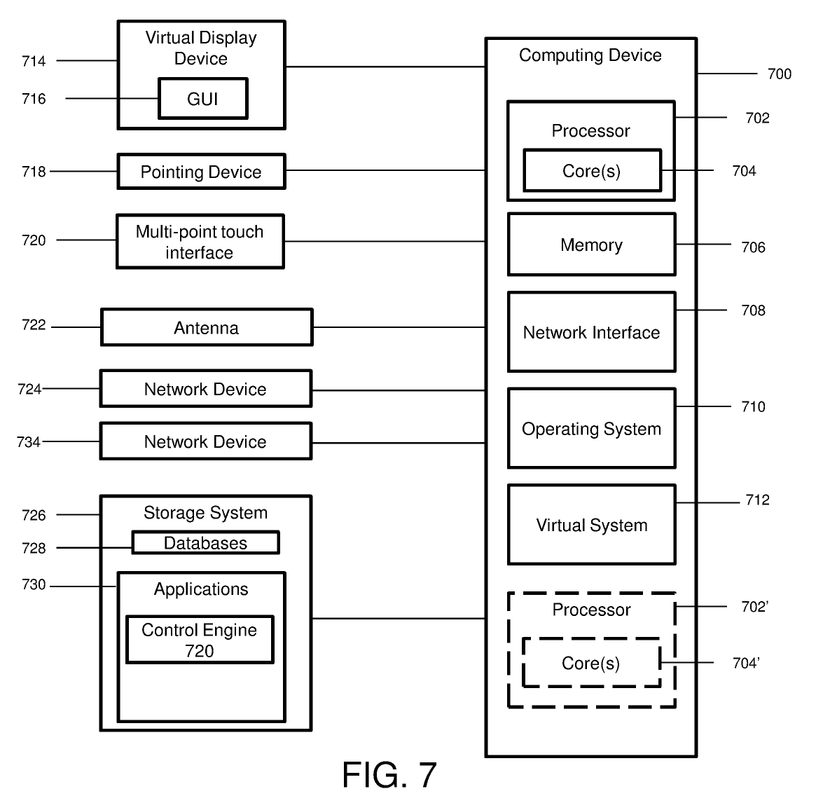

FIG. 7 is a block diagram of an example computing device for implementing exemplary embodiments of the present disclosure. Embodiments of the computing device 700 can implement embodiments of the blockchain ownership storage system. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 706 included in the computing device 700 may store computer-readable and computer-executable instructions or software (e.g., applications 730 such as the control engine 720) for implementing exemplary operations of the computing device 700. The computing device 700 also includes configurable and/or programmable processor 702 and associated core(s) 704, and optionally, one or more additional configurable and/or programmable processor(s) 702′ and associated core(s) 704′ (for example, in the case of computer systems having multiple processors/cores), for executing computer-readable and computer-executable instructions or software stored in the memory 706 and other programs for implementing exemplary embodiments of the present disclosure. Processor 702 and processor(s) 702′ may each be a single core processor or multiple core (704 and 704′) processor. Either or both of processor 702 and processor(s) 702′ may be configured to execute one or more of the instructions described in connection with computing device 700.

Virtualization may be employed in the computing device 700 so that infrastructure and resources in the computing device 700 may be shared dynamically. A virtual machine 712 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof. The computing device 700 can receive data from input/output devices such as, an image capturing device 734. The image capturing device 734 can capture still or moving images. A user may interact with the computing device 700 through a visual display device 714, such as a computer monitor, which may display one or more graphical user interfaces 716, multi touch interface 720 and a pointing device 718.

The computing device 700 may also include one or more storage devices 726, such as a hard-drive, CD-ROM, or other computer readable media, for storing data and computer-readable instructions and/or software that implement exemplary embodiments of the present disclosure (e.g., applications such as the control engine 720). For example, exemplary storage device 726 can include one or more databases 728 for storing information associated with representations of ownership and warranty associated with the physical object. The databases 728 may be updated manually or automatically at any suitable time to add, delete, and/or update one or more data items in the databases.

The computing device 700 can include a network interface 708 configured to interface via one or more network devices 724 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 722 to facilitate wireless communication (e.g., via the network interface) between the computing device 700 and a network and/or between the computing device 700 and other computing devices. The network interface 708 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

The computing device 700 may run any operating system 710, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 700 and performing the operations described herein. In exemplary embodiments, the operating system 710 may be run in native mode or emulated mode. In an exemplary embodiment, the operating system 710 may be run on one or more cloud machine instances.

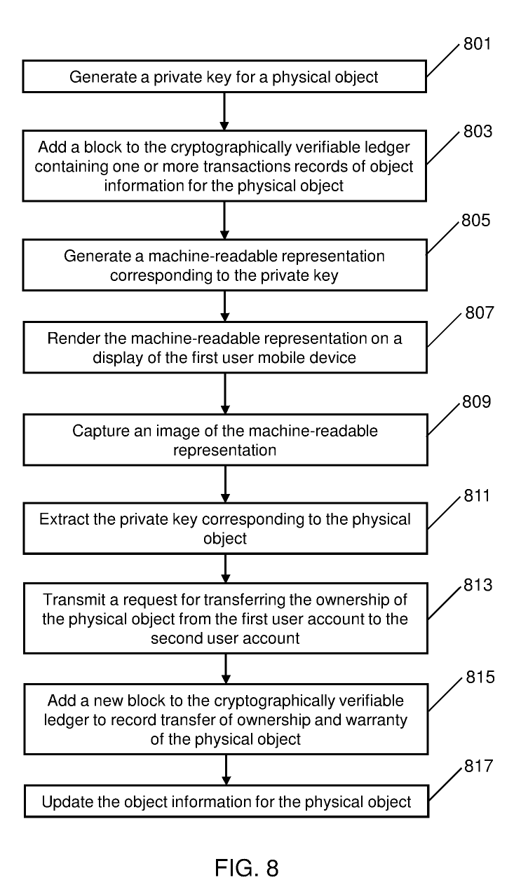

FIG. 8 is a flowchart illustrating a process implemented by the blockchain warranty-ownership storage system in accordance with an exemplary embodiment. The blockchain system includes one or more non-transitory computer-readable media storing a cryptographically verifiable ledger represented by a sequence of blocks. Each block contains one or more transactions records and each subsequent block contains a hash value associated with the previous block. At least one of the blocks contains transaction records associated with ownership, a service plan, and/or a warranty of a physical object, and the blocks that contains transaction records associated with ownership and warranty of the physical object includes restrictions associated with transfers of the physical object. At step 801, when the physical object, such as a car, is purchased by a first user, the system generates a private key (e.g., a unique key or hash) for the physical object. The private key is based on a unique identifier assigned to the physical object and is required to transfer ownership and warranty information. At step 803, the system adds a block to the cryptographically verifiable ledger which contains one or more transactions records of object information for the physical object, and the object information is associated with ownership and warranty of the physical object being transferred to the user account of the first user. The object information can further include information regarding service, insurance, repair, recall, and routine maintenance. The block is signed using a user ID associated with the first user and includes a public key from the first user which comprises a hash of the private key assigned to the physical object and the unique identifier associated with the first user. In exemplary embodiments, a first user mobile device associated with the first user can received the private key by scanning a first machine-readable representation encoded with the private key and/or can receive the private key via radiofrequency communication. The first user mobile device can execute an application that encrypts the private key and stores the encrypted private key in a secure storage location on the user device.

When the physical object, for example, the car, is sold from the first user to a second user, the first user can send a request from the first user mobile device to the system for transferring the car. Then at step 805, in response to the request from the first user, the first user mobile device can generate a second machine-readable representation corresponding to the private key. For example, the machine-readable representation can be a barcode encoded with the private key. At step 807, the machine-readable representation can be rendered on the display of the first user mobile device in response to execution of a first mobile application.

At step 809 the second user, who purchases the car from the first user, can use a second mobile application executable on a second user mobile device associated with the second user account to capture an image of the machine-readable representation rendered on the display of the first mobile device. For example, the second user can scan the barcode using his/her mobile device. Then at step 811, the second mobile application can extract the private key corresponding to the purchased car from the captured image of the machine-readable representation. In response to extraction of the private key from the machine-readable representation, the second mobile application can transmit an erase message to the first user mobile device with instructions for erase the private key from memory on the first user mobile device. The erase message can cause the first mobile application to erase the private key from the memory and transmit an acknowledgement message to the second user mobile device. In some embodiments, the private key can be transferred via radiofrequency communications between the first and second user mobile devices such that a machine-readable representation is not displayed by the first user mobile device.

At step 813, the second mobile application verifies a digital signature of the first user and the public key associated with the previous block based on the private key and then can transmit a request, to the computing system, for transferring the ownership of the car associated with the private key from the first user account to the second user account. At step 815, in response to receiving the request for transferring the ownership of the car, the computing system adds a new block to the cryptographically verifiable ledger to record transfer of ownership and warranty of the car from the first user account to the second user account. The new block can be signed by a digital signature of the second user based on a user ID associated with the second user and can include a public key corresponding to a hash of the user ID associated with the second user and the private key. The computing system can also terminate user access by the first user account to the object information of the car, in response to receiving the request for transferring the ownership of the car. At step 817, the object information for the car is updated with information from the second user account, such as the information about the second user who is the new owner of the car.

In accordance with embodiments of the present disclosure, the object information further includes a schedule of upcoming events related to the object information, and the computing system can promote the upcoming events related to the object information to the owner of the physical object. And in response to recording transfer of ownership of the physical object from the first user account to the second user account, the computing system can transfer services provided to the first user account to the second user account according to the information regarding service included in the object information.

In accordance with embodiments of the present disclosure, when the object information of the physical object is altered, for example, the car can be altered by adding tinted windows, adding after-market sound system, etc., the computing system can add additional blocks containing object alteration records into the cryptographically verifiable ledger.

In accordance with embodiments of the present disclosure, the object information can include photographs indicating object condition of the physical object at the time of initial sale, accident, repair and transfer.

In accordance with embodiments of the present disclosure, the computing system can assign a blockchain ID associated with the physical object based upon an existing physical identification related to the physical object. For example, if the physical object is a car, the blockchain ID associated with the car can be the VIN of a car.

In accordance with embodiments of the present disclosure, the computing system can search the object information according to a user operation by the owner of the physical object.

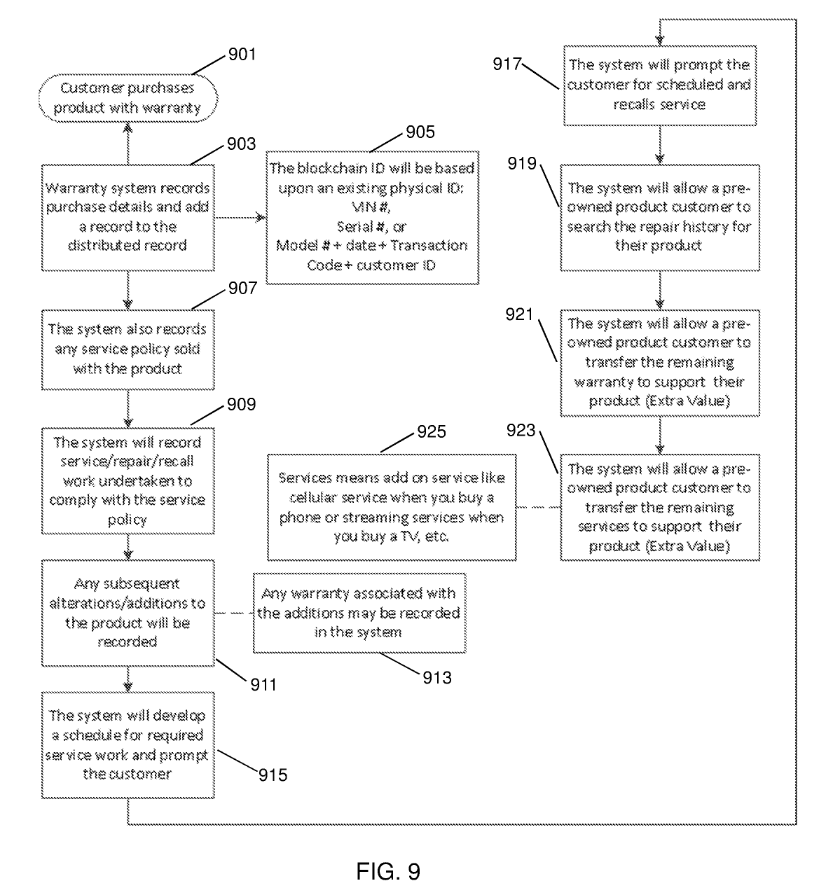

FIG. 9 is a flowchart illustrating a process implemented by the blockchain warranty-ownership storage system in accordance with another exemplary embodiment. After a user purchases a product with warranty at step 901, the warranty system can record purchase details and add a record to the distributed record at step 903. At step 905, the system can assign a blockchain ID associated with the product based upon an existing physical ID, such as VIN number, Serial number, or a combination of at least one of the model number, manufacture date, transaction code, and customer ID.

At step 907, the system records the service policy sold together with the product, and at step 909, the system can also record service, repair, and recall work undertaken to comply with the service policy. At step 911, the subsequent alterations and additions to the product can be recorded. The system can also record the warranty associated with the additions at step 913. At step 915, the system can develop a schedule for the required service work and prompt the schedule to the user who purchases the product. At step 917 the system can prompt the user for scheduled and recall service.

At step 919, the system can allow the user who purchases the pre-owned product to search the repair history for the product. At step 921, the system can allow the user who purchases the pre-owned product to transfer the remaining warranty to support the product which adds extra value to the product. At step 923, the system can allow the user who purchases the pre-owned product to transfer the remaining services to support the product, which also adds extra value to the product. For example, as shown in block 925, services can be add on service such as cellular service when the user buy a phone, or streaming services when the users buy a TV, etc.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for key exchange in a blockchain based system associated with warranty-ownership of physical objects, the system comprising:
one or more non-transitory computer-readable media configured to store a cryptographically verifiable ledger represented by a sequence of blocks;
a computing system in communication with a plurality of user mobile devices, each being associated with a user account and the one or more non-transitory computer-readable media, the computing system configured to:
generate a private key for a physical object, the private key being based on a unique identifier assigned to the physical object and being required to transfer ownership and warranty information;
add a block to the cryptographically verifiable ledger containing one or more transactions records of object information for the physical object, wherein the object information is associated with ownership and warranty of the physical object being transferred to a first user account;
generate a machine-readable representation corresponding to the private key in response to a request from a first user mobile device of the plurality of mobile devices associated with the first account; and
render the machine-readable representation on a display of the first user mobile device in response to execution of a first mobile application;
a second mobile application executable on a second user mobile device of the plurality of user mobile devices that is associated with a second user account, the second mobile application when executed:
captures an image of the machine-readable representation rendered on the display of the first mobile device;
extracts, from the captured image of the machine-readable representation, the private key corresponding to the physical object; and
transmits, to the computing system, a request for transferring the ownership of the physical object associated with the private key from the first user account to the second user account;
wherein the computing system, in response to receiving the request for transferring the ownership of the physical object, is configured to:
add a new block to the cryptographically verifiable ledger to record transfer of ownership and warranty of the physical object from the first user account to the second user account;
update the object information for the physical object with information from the second user account.

2. The system of claim 1, wherein, in response to extraction of the private key from the machine-readable representation, the second mobile application when executed by the second user mobile device cause the second user mobile device to transmit an erase message to the first user mobile device with instructions for erase the private key from memory on the first user mobile device, which cause the first mobile application executing on the first user mobile device to erase the private key from the memory and transmit an acknowledgement message to the second user mobile device.

3. The system of claim 1, wherein the computing system is configured to:
in response to receiving the request for transferring ownership of the physical object, terminate user access by the first user account to the object information of the physical object.

4. The system of claim 1, wherein the object information further includes information regarding service, insurance, repair, recall, and routine maintenance.

5. The system of claim 4, wherein the object information further includes a schedule of upcoming events related to the object information, and the computing system is configured to:
promote the upcoming events related to the object information to the second user account.

6. The system of claim 4, wherein the computing system is configured to: in response to recording transfer of ownership of the physical object from the first user account to the second user account, transfer services provided to the first user account to the second user account according to the information regarding service included in the object information.

7. The system of claim 1, wherein when the object information of the physical object is altered, and the computing system is configured to:
add additional blocks containing object alteration records into the cryptographically verifiable ledger.

8. The system of claim 1, wherein the object information includes photographs indicating object condition of the physical object at the time of initial sale, accident, repair and transfer.

9. The system of claim 1, wherein the computing system is configured to:
assign a blockchain ID associated with the physical object based upon an existing physical identification related to the physical object.

10. The system of claim 1, wherein the computing system is configured to:
search the object information based on a user operation by the second user account associated with ownership of the physical object.

11. A method for key exchange in a blockchain based system associated with warranty-ownership of physical objects, the method comprising:
generating a private key for a physical object, by a computing system in communication with a plurality of user mobile devices each of which is associated with a user account and one or more non-transitory computer-readable media, the private key being based on a unique identifier assigned to the physical object and being required to transfer ownership and warranty information;
adding, by the computing system, a block to a cryptographically verifiable ledger containing one or more transactions records of object information for the physical object, the cryptographically verifiable ledger being represented by a sequence of blocks that is stored in the one or more non-transitory computer-readable media, wherein the object information is associated with ownership and warranty of the physical object being transferred to a first user account;
generating, by the computing system, a machine-readable representation corresponding to the private key in response to a request from a first user mobile device of the plurality of mobile devices associated with the first account;
rendering, by the computing system, the machine-readable representation on a display of the first user mobile device in response to execution of a first mobile application;
capturing, by a second mobile application executable on a second user mobile device of the plurality of user mobile devices that is associated with a second user account, an image of the machine-readable representation rendered on the display of the first mobile device;
extracting, from the captured image of the machine-readable representation, the private key corresponding to the physical object, by the second mobile application;
transmitting, to the computing system, a request for transferring the ownership of the physical object associated with the private key from the first user account to the second user account, by the second mobile application;
adding, by the computing system in response to receiving the request for transferring the ownership of the physical object, a new block to the cryptographically verifiable ledger to record transfer of ownership and warranty of the physical object from the first user account to the second user account; and
updating, by the computing system, the object information for the physical object with information from the second user account.

12. The method of claim 11, further comprising:
in response to extraction of the private key from the machine-readable representation, transmitting, by the second mobile application executing on the second user mobile device, an erase message to the first user mobile device with instructions for erase the private key from memory on the first user mobile device, and erasing the private key from the memory and transmitting an acknowledgement message to the second user mobile device by the first mobile application executing on the first user mobile device.

13. The method of claim 11, further comprising:
in response to receiving the request for transferring ownership of the physical object, terminating user access by the first user account to the object information of the physical object.

14. The method of claim 11, wherein the object information further includes information regarding service, insurance, repair, recall, and routine maintenance.

15. The method of claim 14, wherein the object information further includes a schedule of upcoming events related to the object information, and the method further comprising:
promoting the upcoming events related to the object information to the second user account.

16. The method of claim 14, further comprising:
in response to recording transfer of ownership of the physical object from the first user account to the second user account, transferring services provided to the first user account to the second user account according to the information regarding service included in the object information.

17. The method of claim 11, further comprising:
when the object information of the physical object is altered, adding additional blocks containing object alteration records into the cryptographically verifiable ledger.

18. The method of claim 11, wherein the object information includes photographs indicating object condition of the physical object at the time of initial sale, accident, repair and transfer.

19. The method of claim 11, further comprising:
assigning a blockchain ID associated with the physical object based upon an existing physical identification related to the physical object.

20. The method of claim 11, further comprising:
searching the object information based on a user operation by the second user account associated with ownership of the physical object.
